(19) United States
(12) Patent Application Publication
(10) Pub. No.: US 2016/0335092 A1
(43) Pub. Date: Nov. 17, 2016

(54) Using Very Long Instruction Word VLIW Cores In Many-Core Architectures

(71) Applicant: Bruce Ledley Jacob, Arnold, MD (US)

(72) Inventor: Bruce Ledley Jacob, Arnold, MD (US)

(21) Appl. No.: 15/046,438

(22) Filed: Feb. 17, 2016

Related U.S. Application Data
(60) Provisional application No. 62/135,157, filed on Mar. 18, 2015.
(60) Provisional application No. 62/151,555, filed on Apr. 23, 2015.

(51) Int. Cl. G06F 9/38; G06F 15/76

(52) U.S. Cl. CPC G06F 9/3867; G06F 15/76

(57) ABSTRACT

Current ultra-high-performance computers execute instructions at the rate of roughly 10 PFLOPS and dissipate power in the range of 10 MW. The next generation of exascale machines will need to execute instructions at EFLOPS rates-100× as fast as today's—but without dissipating any more power. To achieve this challenging goal, the emphasis will be on power-efficient execution, and for this we propose VLIW-CMP as a general architectural approach that will improve significantly on the power efficiency of existing solutions. To make VLIW work efficiently, we describe multiple mechanisms: software register-renaming, a hardware facility in which data forwarding is controlled completely by the compiler; and a disjunct register file, which reduces both the die area required by the register file and the power dissipated by the register file. The preferred embodiments disclose power saving methods and devices for use in computers with parallel processing units, or any high-performance processors with multiple pipelines or parallel processing. These power saving methods and devices include especially especially (1) data forwarding and register-file ports, (2) the use of VLIW core architectures to reduce a manycore chip's off-chip memory-bandwidth needs, (3) renaming registers in software, and (4) disjunct register files, which are widely applicable to any processor with multiple pipelines.

### CROSS-REFERENCES TO RELATED APPLICATIONS

The present application claims priority benefit of three U.S. provisional applications: (1) No. 62/117,235 filed Feb. 17, 2015; (2) No. 62/135,157 filed Mar. 18, 2015, and (3) No. 62/151,555 filed on Apr. 23, 2015.

### TECHNICAL FIELD

This disclosure relates to power saving methods and devices in high performance computer architectures, more specifically, how to significantly increase the chip-wide OPS (operations per second) without also significantly increasing the power requirements for that significant increase in OPS.

### BACKGROUND

Though the disclosed embodiments use prior art VLIW processors, the invention is not limited to being used in VLIW processors. A very long instruction word (VLIW) processor is a computer processing unit with instruction-level parallel architecture. The VLIW processor executes multiple instruction(s) simultaneously that were recognized to be parallel and scheduled as such during program compilation by the compiler. Since the execution sequence of the operating instructions is already determined by the compiler, each VLIW processor can process the multiple operations in parallel, without requiring dynamic out-of-order/scheduling hardware, which is well known to require significant power and energy. Thus, the VLIW processor provides excellent computation efficiency, as its statically scheduled nature means that the hardware complexity is low. Its efficiency grows as the hardware complexity decreases and as the ability of the corresponding compiler to generate parallel code increases. The compiler renders unnecessary any dynamic out-of-order hardware by shouldering the burden of detecting and scheduling independent instructions to execute in parallel, which it does at compile time.

A VLIW processor makes it possible to execute programs with a high degree of instruction parallelism, with no hardware overhead required for detection and scheduling of independent, parallel instructions. In each instruction cycle the VLIW processor fetches an instruction word that contains a fixed number of instructions, greater than one, (often called operations). The VLIW processor executes these operations in parallel in the same instruction cycle (or cycles). Thus, the VLIW processor contains a plurality of functional units, each capable of executing one of the operations from the same instruction word.

These VLIW processors along with the disclosed apparatus and methods are all focused on power savings in high performance computer architectures. The current generation of supercomputers is now moving into exascale computing, i.e., computing systems capable of at least one exa-FLOPS, or a billion billion calculations per second. However, the present highest-performance systems are based on processors that perform dynamic out-of-order scheduling in hardware, and each processor can dissipate hundreds of Watts by itself. With the move to exascale (as noted, computing at the level of exa-FLOPS is equivalent to 1,000,000,000 GFLOPS or 1,000,000 TFLOPS or 1,000 PFLOPS), systems based on this dynamic hardware-centric architecture require staggering amounts of power. Existing systems dissipate 10 s of MWatts, and therefore one cannot simply make them bigger to support exascale: while such an approach would achieve the desired aggregate performance, the power cost would be untenable.

Thus, the key question in the move to exascale is not “can we build a machine that executes this fast?” but rather “can we build one without requiring a nuclear reactor to power it?”

Power levels for existing supercomputers are currently at the very edge of reasonable, low 10 s of MWatts, and it is a stated goal that a 1 EFLOPS machine must not dissipate significantly more power than today's low-double-digit PFLOPS machines. This leads to necessary conditions such as approaching 1 TFLOPS per Watt at the CPU or core level, and the ability to build a 1-10 PFLOPS rack that dissipates 10-100 kW.

Current systems are significantly off this mark: typical CPUs execute at roughly 0.01 TFLOPS per Watt, and typical cabinets dissipate on the order of 100 kW to produce roughly 0.1 PFLOPS of execution. Achieving the desired level of performance efficiency will demand trade-offs between numerous conflicting requirements:
the desire for high-performance cores, to achieve good single-thread performance
the desire for low-power cores, to meet stringent energy/power limitations
the desire for small numbers of nodes, to reduce the bandwidth (and thus power) needed of the system interconnect
the desire for large numbers of nodes, to achieve 1000 PFLOPS

To address the power issue, some recent CPU designs have shied away from using numerous multi-issue, dynamic out-of-order cores on-chip, because those designs dissipate too much power; these recent designs have instead favored large numbers of simple, single-issue, in-order cores. Some architectures use a heterogeneous mix including a small number of high-performance cores mixed with a larger number of simple cores, but even then, when these designs tile large numbers (tens to hundreds) of cores in an array, those cores are single-issue, in-order designs. The well-known downside of this approach is that, where it relies upon single-issue cores (which can only execute a single instruction at a time), it sacrifices single-thread performance. This means that hardware, given any one stream of instructions (a given single thread), can issue and execute only one instruction at a time, even if there is more instruction-level parallelism available within the instruction stream. In addition, the large number of cores used demands significant bandwidth from main memory to avoid overcrowding the memory channel.

When the computer-design community hit a power wall using complex cores in the early 2000 s, it took a 180° turn and went as far as possible in the opposite direction, avoiding the middle ground entirely. But, as disclosed herein, this middle ground is the most power-efficient part of the design space.

To illustrate, a prior art many-core chip is shown in FIG. 1 using simple cores 18. These numerous pipelines 12 are tiled across the chip 20, each with its own L1 instruction cache 10, its own L1 data cache 14, and its own register file 16. While this design is much more power-efficient than using highly out-of-order, high-performance cores that perform dynamic instruction scheduling in hardware, one can still do significantly better in both single-thread performance and memory bandwidth required.

### SUMMARY OF THE INVENTION

The disclosed power saving techniques recognizes that in real life processing applications to reach exascale level of processing, executing instructions at EFLOPS rates these processors cannot dissipating any more power than the current generation of 10 PFLOPS, dissipating power in the range of 10 MW.

Thus, disclosed are power saving mechanisms for use in computers with parallel processing units, or any high-performance processors with multiple pipelines or parallel processing. These power saving methods and devices include (1) data forwarding and register-file ports, (2) the use of VLIW core architectures to reduce a manycore chip's off-chip memory-bandwidth needs, (3) renaming registers in software, and (4) disjunct register files, which are widely applicable to any processor with multiple pipelines. Additionally, the disclosed mechanisms are ways to significantly increase the chip-wide OPS (operations per second) without also significantly increasing the power requirements for that significant increase in OPS, and these mechanisms, used separately or together, provide significant increases in integrated circuit (IC)-wide OPS without a significant increase in the power requirements of the IC.

These mechanisms include data forwarding and register-file ports, renaming registers in software, and disjunct register files. Combined these mechanisms used provide power-efficient high-performance processing with multiple pipelines or parallel processing.

Viewed from one aspect the present invention provides a VLIW processor comprising multiple instruction pipelines, one or more of the pipelines having multiple stages. The VLIW instruction-word is compiled with multiple parallel instructions to be executed by the instruction pipelines, and the VLIW processor has multiple data-forwarding paths that allow data from one pipeline to be used by another pipeline without having to be written through to a register file first. The VLIW instruction-word contains information that explicitly directs the flow of the data on the data-forwarding paths, and at least one of the instructions in the VLIW instruction word has a no write-register specifier; the corresponding pipeline has no write-port connection to the register file; while the pipeline executing regular instructions would normally write the register file.

In preferred embodiments the VLIW processor further comprises a compiler capable of exploiting the VLIW processor parallelism to the extent an application has said parallelism; and the data-forwarding paths.

Another preferred way comprises m pipeline stages between register-file-read and register-file-write stages in the VLIW processor pipeline. The width n of the machine, the width comprised of the number of instruction pipelines; thereby creates at least mn data-forwarding paths.

Viewed from another aspect the present invention provides a VLIW processor further comprising registers renamed by the compiler to reference explicitly the data-forwarding paths; whereby power is conserved because there is no comparison between instructions during pipeline operation.

Viewed from a further aspect the present invention provides a VLIW processor further comprising registers renamed by a compiler to reference explicitly the data-forwarding paths; whereby power is conserved because there is no comparison between instructions during pipeline operation.

Viewed from a complementary aspect the VLIW processor is a 4-pipeline VLIW processor and uses three bits to identify a forwarding path; one bit of the three bits indicates which pipeline stage produces the forwarded result; and two bits indicates which pipeline is the source.

Viewed from a further aspect the present invention the VLIW processor includes additional FIFO registers beyond the end of the pipeline to hold forwarding values; and the three bits identifying the forwarding path and the two bits indicate the pipeline source can scales to can both increase for wider and longer pipelinesthe processor uses more than one bit to indicate which pipeline stage produces the forwarded result, thereby scaling to more forwarding paths selectable by the compiler.

Viewed from yet a further aspect the present invention a processor core comprises multiple instruction pipelines and has an architecturally specified monolithic register file of n R registers; the processor core contains a plurality of physical register files, at least one of which has fewer than n R registers; and one or more of the instruction pipelines is connected to each of the physical register files.

Viewed from yet another complementary aspect of the present invention the processor core has forwarding which enables data to be sent directly from a later stage in a pipeline without requiring the earlier stage to wait to get the data out of one of the physical register files.

Viewed from another aspect the present invention the processor core has instruction pipelines dynamically detecting when one instruction reads a register that an instruction ahead of it in the pipeline writes; and an enabled MUX, corresponding to the register, directly passing data to the instruction pipeline needing the data without having to go through an intervening register.

Viewed from yet another complementary aspect of the present invention the processor core uses a compiler to insert embedded forwarding signals in a multi-pipeline instruction; and the embedded forwarding signals in the compiled multi-pipeline instruction pipeline forwards data to another pipeline in a pipeline core group.

Viewed from another aspect the present invention a disjunct register file comprises a single, logically monolithic register file, composed of two parts; (1) a small physical register file, small when compared to the size of the logically monolithic register filerest of the disjunct register file, and (2) a larger part physical register file making up the rest of the logically monolithic disjunct register file; most of pipelines in a processor core connect to the small physical register file; and a subset of the pipelines are connected to the larger rest of the larger part of the logically monolithic disjunct physical register file; whereby wiring on an integrated circuit die is kept at a minimum less than that required of a full-sized physical register file connected to all pipelines.

Viewed from yet another aspect the present invention a disjunct register file has a single, logically monolithic register file, composed of two parts; (1) a small physical register file, small when compared to the size of the logically monolithic register file, and (2) a larger physical register file making up the rest of the logically monolithic register file; most of pipelines in a processor core connect to the small physical register file; and a subset of the pipelines connects to the larger physical register file; whereby register-file read/write power on an integrated circuit die is less than that required of a full-sized physical register file connected to all pipelines.

Viewed from another aspect the present invention a manycore chip has multiple processing cores; each core being a very long instruction word (VLIW) processor core; whereby off-chip bandwidth is reduced compared to a manycore chip containing a comparable number of pipelines but arranged as single-issue pipelines.

Viewed from another aspect the present invention the manycore chip contains multiple processing cores; each core being a VLIW processor core; whereby power dissipation is reduced compared to a manycore chip containing a comparable number of pipelines but arranged as dynamically scheduled out-of-order pipelines.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 discloses an example of a prior art manycore, many CPU organization.

FIG. 2 is an embodiment of the VLIW manycore CPU organization.

FIG. 3 shows a pipeline organization of forwarding MUXes in one embodiment.

FIG. 4 shows a register-specifier format of the pipeline as disclosed in FIG. 2.

FIG. 5 discloses an embodiment of a register specific bit values in software renaming.

FIG. 6 shows an embodiment of a disjunct register file combining 8-entry and 56-entry files to create a 64-entry file.

### DESCRIPTION OF PREFERRED EMBODIMENTS

The preferred embodiments disclose power saving methods and devices for use in computers with parallel processing units, or any high-performance processors with multiple pipelines or parallel processing. These power saving methods and devices include especially (1) data forwarding and register-file ports, (2) the use of VLIW core architectures to reduce a manycore chip's off-chip memory-bandwidth needs, (3) renaming registers in software, and (4) disjunct register files, which are widely applicable to any processor with multiple pipelines.

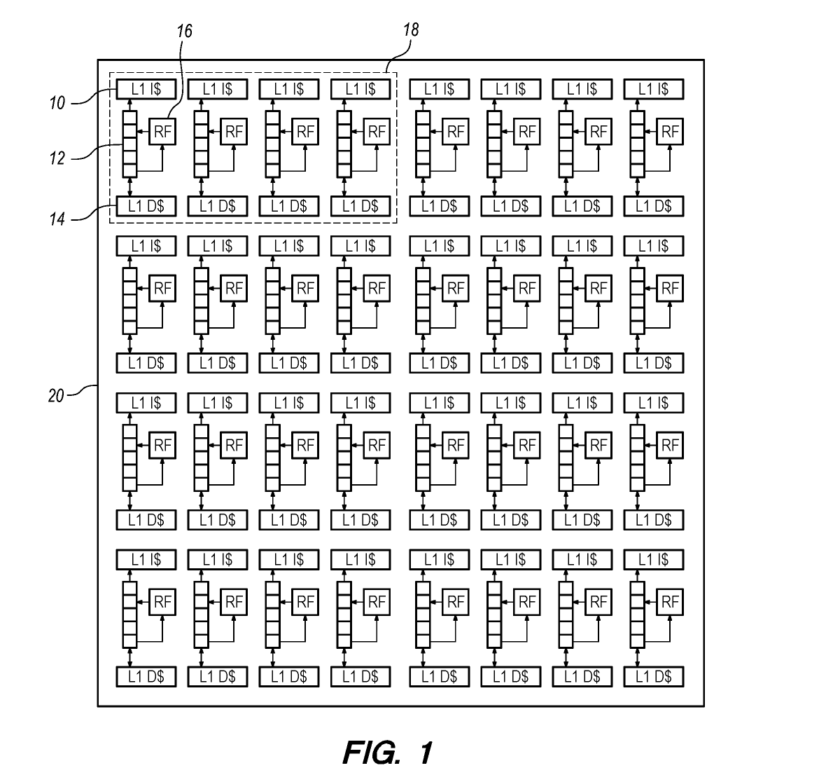

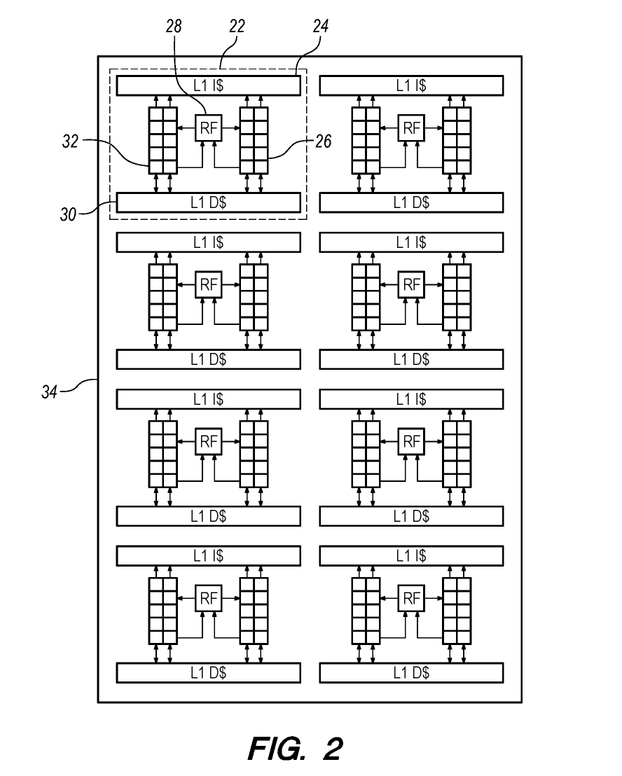

One embodiment of an architecture that explicitly directs the flow of the data on the data-forwarding paths and uses a disjunct register file is disclosed in FIG. 2. FIG. 2 reveals fundamental core building blocks that are not single-issue cores like the prior art pipeline of FIG. 1 but instead n-issue or n-way VLIW cores 22 that have n pipelines for instruction execution. In FIG. 2 the n pipelines are four (4), i.e., 4-way VLIW cores 22. Note that, even though the diagram shows each VLIW pipeline 26, 32 having equal access to all resources, this need not be the case: not every pipe needs a data memory port 26, 32; not every pipe needs a hardware multiplier in its ALU; etc. Commercial VLIW designs such as the TMS320C6000 from Texas Instruments have already explored this asymmetric-pipe design space and have shown it to be viable.

Accordingly, there are a few important issues that distinguish the disclosed embodiment architecture in FIG. 2, compared to the prior art architecture in FIG. 1:
The total number of execution pipelines chip-wide is (or at least can be) the same. Thus the aggregate performance (instructions per clock) should remain the same, assuming the VLIW width n is small enough to provide near-linear speedups.
The number of register files 28 in FIG. 2 is lower than the number of register files 16 in FIG. 1 by a factor of n. This should improve both power dissipation and die area at the chip level.
The pipeline forwarding and register-file complexity can increase with VLIW, and two solutions are given later that eliminate any additional complexity.
The L1 cache resources 24 30 (e.g., cache size, number of ports) in FIG. 2 could remain the same as the L1 cache resources 10 14 in FIG. 1, or they could be decreased. Decreasing the resources should improve both power dissipation and die area at the chip level. Keeping them the same should improve performance, as it effectively increases the code storage per thread by a factor of n. The increase in data storage per thread would be an appropriate addition to the increased number of execution pipelines.
The on-chip interconnect in FIG. 2 would have fewer endpoints by a factor of n than the interconnect in FIG. 1; thus its complexity should decrease, potentially improving power dissipation and/or die area.
Any shared L2 caches should have fewer simultaneous threads vying for resources, potentially reducing complexity of the design.
The off-chip memory-bandwidth requirements are reduced by almost a factor of n, due to the reduced number of cores. This is “almost” a factor of n and not necessarily equal to n because each VLIW pipeline may be able to execute more than one memory operation per cycle.

The bottom line is that, in a VLIW-CMP (VLIW chip multiprocessor (CMP) architecture), power will decrease relative to existing architectures, total aggregate performance (chip-wide IPC (Instructions Per Cycle)) will remain roughly the same (assuming that n is chosen small enough for the VLIW compiler to extract near-linear parallelism), memory-bandwidth requirements will decrease significantly, and single-thread performance will improve by almost a factor of n. This is what is needed to reach exascale; moreover, this type of attention to efficiency optimization will be required, at all levels, to build power-efficient exascale computers.

Accordingly, FIG. 1 and FIG. 2 contain the same number of execution units (pipelines), but they are simply arranged in a different manner (as 4-way VLIW cores 22 in FIG. 2, each corresponding to a group of four (4) independent single-issue cores 18 in FIG. 1), and this difference in arrangement yields tremendous benefits. The group 18 of four pipelines 12 in FIG. 1 is a group of four distinct cores. Each executes a single program, or a single thread-subset of a program. Each pipeline can only do one thing at a time, and so its performance is limited to issuing (or executing) only one instruction at any one cycle of the processor clock.

In contrast, the group 22 of four pipelines 32 and 26 in the FIG. 2 is a group of four pipes 32 and 26 all working together within one single VLIW core to execute a single stream of instructions. Thus, the difference between the four pipelines in FIGS. 2, 32 and 26, is their capability to work together to execute a single program, or a single thread-subset of a program. The four pipelines in FIGS. 2, 32 and 26, can do four things at a time, and so the performance of this arrangement is up to four times as fast as group 18 in FIG. 1

Note: the variable n is used throughout this disclosure and is consistent in all its uses, but since it is used frequently an explanation of its multi-use is as follows. Comparing FIG. 1 to FIG. 2, one moves from a single-issue model (FIG. 1) to a VLIW multi-issue model (FIG. 2), which gathers together n single-issue pipelines and replaces each n-core group with a single n-issue VLIW core having the same number of total pipes. When this happens, the number of cores goes down by a factor n, the number of register files goes down by a factor of n, the number of caches goes down by a factor of n, and the number of network endpoints on the chip (the number of cores) goes down by a factor of n, etc.

Thus, as noted, the number of register files is equal to the number of cores, so when the number of cores is reduced, so are the number of register files. In a VLIW core, or in any multi-issue core, all of the pipelines share the same register file. Additionally, while the number of caches might go down by a factor of n, one may offset this by increasing the capacity of each core's cache by up to a factor of n, which would keep the same amount of die area dedicated to cache storage. Moreover, the reduced number of cores means that the off-chip bandwidth requirements will decrease.

Also, when you replace each group of n single-issue cores with a single VLIW n-issue core, the number of threads running on the chip is reduced by a factor of n (because of the reduced the number of cores, reduced by a factor of n), but the per-thread performance of each core increases by a factor of n because each core is now n-wide issue; it can therefore execute n simultaneous instructions, giving it a maximum speedup of n over a single-issue core. So the processor can get the work done faster by up to a factor of n. This is heavily dependent on a compiler being able to exploit parallelism, and an application that has parallelism to exploit, but at a high level, replacing a 1-issue core with an n-issue core gets you a per-thread speedup of n, with the same number of aggregate operations per cycle across the chip.

### Problems and Solutions in the Disclosed Embodiments

Two problems to solve with the complexities and increased power dissipation brought about by the disclosed embodiments, of VLIW and other architectures having multiple pipelines that share a register file, are (a) data forwarding across multiple pipelines and (b) multiple read and write ports into the register file. (Data forwarding is also called bypassing and sometimes short-circuiting. For example, forwarding could use the inter-stage pipeline registers to pass the results of previous instructions directly back to the function units that require them without having to go through any intervening register.)

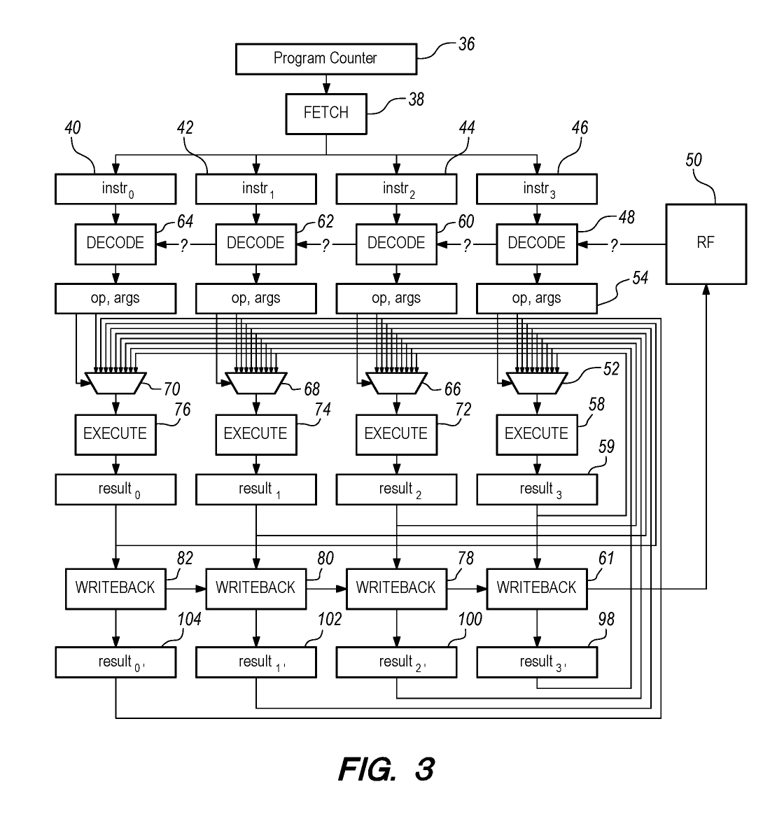

Thus, forwarding in the preferred embodiments is the capability of a group of MUXes (for example 52, 66, 68, 70 in FIG. 3) that enable data to be sent directly from a later stage in a pipeline to an earlier stage in the pipeline, without requiring the earlier stage to wait to get the data out of the register file. Thus, in most pipelines, this is useful because the result of the pipeline's calculations are written to the register file only at the end of the pipeline. For example, if two different stages of the pipeline are operating on two back-to-back instructions, and the first instruction produces data that the second instruction requires, then it is a waste of time to have the second instruction wait until the first finishes the pipeline and writes its result to the register file. Rather, in forwarding, the pipeline dynamically detects when one instruction reads a register that an instruction ahead of it in the pipeline writes, and in such an event the corresponding MUX is enabled, and the data is directly passed to the instruction needing the data without having to go through an intervening register.

Additionally, in the prior art, forwarding is detected dynamically by the pipeline, which, at a certain stage in the pipeline compares instructions and determines which data needs forwarding. For example, with n simultaneous instructions in n pipelines, at a certain stage in the pipeline the hardware compares two operands that the instruction reads against the output register of every m instruction that is still ahead of it in the pipeline. So, because the hardware does this for each of the n instructions at that given stage, this involves 2 mn² comparisons, to determine which forwarding path(s) to enable.

In the disclosed embodiments all these comparisons, while the pipelines are operating, are eliminated. At compile time a control signal is inserted in, for example, a multi-pipeline VLIW instruction (which the pipeline then dynamically detects and then forwards without any comparisons). Thus, the forwarding signals embedded in the compiled VLIW instruction by the compiler eliminate 2 mn comparisons during pipeline operation, as well as the redundant read of the register file. Thus, in the disclosed embodiments, a pipeline can forward data to another pipeline in the same core group 22 of the four pipelines 32, 26 shown in FIG. 2.

### Forwarding and Register-File Ports

There are several technical issues that need to be addressed in forwarding and register file ports in VLIW architectures:
VLIW requires complex data-forwarding logic between its multiple pipelines, which leads to increased power dissipation.
VLIW requires a complex register file to support its multiple pipelines; the increased number of read/write ports on the register file leads to more complex circuits and increased power dissipation.
VLIW instruction words are bit-limited, in that, to increase the number of pipelines in the core (and therefore the parallelism supported and performance reached), one must find a way to make room for additional instructions by eliminating bits in the instruction word—for example, by reducing the number of opcodes, or reducing the number of registers. A way to increase parallelism without having to sacrifice opcodes or registers is desirable.

The disclosed embodiments reveal two complementary solutions: software register-renaming, which can solve all three of these problems, and disjunct register files, which can solve the complexity and power dissipation of the register file and increase parallelism without having to sacrifice the size of the register file.

### Renaming Registers in Software

As the literature shows clearly, the vast majority of register lifetimes are short; most of a processor's output is temporary and not intended to last long in the register file. This should not be at all surprising, as it is why hardware register renaming works so well, and it is also one of the touted strengths of Tomasulo's Algorithm (Tomasulo's Algorithm is a computer architecture hardware algorithm for dynamic scheduling of instructions that allows out-of-order execution, designed to efficiently utilize multiple execution units, and it is one of the earliest examples of hardware register renaming)—for instance, that long strings of back-to-back writes to the same physical register will ultimately be ignored by the register file, and only the last write will actually cause a physical update. Software register-renaming acts in a similar manner.

In a VLIW pipeline, the number of forwarding paths is mn: the stages m between execute and writeback times the width n of the machine. Rather than have hardware perform dependency-checking across pipelines—i.e., compare every register specifier against every other, which is an expensive O(mn²) priority-encode operation—software register-renaming explicitly encodes the forwarding path under control of the compiler. This produces exactly the same performance; it is simply under the control of the assembler/compiler, not the hardware. Information (e.g., a valid bit) in the instruction word indicates that the associated register specifier indicates not a register in the register file but the output of another instruction still in the pipeline ahead. Thus, the per-operand hardware reduces to a single mn+1-wide multiplexer or a series of n+1-wide multiplexers, in which each select signal comes directly from the instruction word.

The trade-off is that the mechanism cannot easily pass values across an exception boundary. This limitation means that precise interrupts must either wait until it is safe to proceed, by marking individual instructions as interruptible or not; or by taking forwarded values into account, by saving and restoring the contents of the pipeline's internal forwarding registers when taking an interrupt.

The mechanism is illustrated in FIG. 3, which shows the organization of a simple 4-way VLIW pipeline implementing a series of multiplexors 52, 66, 68, 70 each of which is controlled by the compiler. The simple 4-way VLIW pipeline of FIG. 2 includes a set of 2n-wide multiplexers 52, 66, 68, 70 two for each pipe (only one shown, for simplicity), each controlled by software. In this embodiment, three bits of the register specifier identify a forwarding path: one bit indicates whether the source of the data is one or two stages ahead in the pipeline, and two bits indicate the pipeline producing the result. Instructions depending on the result of the instruction immediately before them activate the forwarding path from writeback to execute. To accommodate instructions that depend results two stages ahead, an extra register is placed at the end of the pipeline, in FIG. 3, 98, 100, 102, 104. Instructions depending on the result of the instruction two stages before them 54 activate the forwarding path from this extra register (post-writeback) to the execute stage 58. Embodiments with longer pipelines could simply use longer FIFO structures and wider forwarding MUXes. As disclosed in FIG. 3, the valid bit of the register specifier is known in the decode stage 48, 60, 62, 64; therefore, if it indicates forwarding (or immediate value), the register-file read is deactivated for the corresponding operand during that cycle, avoiding unnecessary register-file read energy.

FIG. 3 has a program counter 36 and the registers that separate the stages of the pipeline that hold the instructions for execution by the next stage of the pipeline: the instr0, 1, 2, 3 registers 40, 42, 44, 46, the op,args registers 54, and the result0, 1, 2, 3 registers 60.

Registers 40, 42, 44, 46 and the “decode” logic 48, 60, 62, 64 represent the decode stage of the pipeline. Registers 54, the MUXing 52, 66, 68, 70 and the “execute” logic 58, 72, 74, 76 represent the execute stage of the pipeline. Registers 98, 100, 102, 104 and the “writeback” logic 61, 78, 80, 82 (which updates the register file 50) represent the writeback stage of the pipeline. These all mirror pipelines in the prior art, in a typical VLIW pipeline, except for the fact that, in this embodiment, the forwarding MUXes 52, 66, 68, 70 are controlled by bits within the instruction word, and the register-file read operation in the decode stage 48, 60, 62, 64 is turned off when the instruction expects a forwarded value.

Prior art pipelines, VLIW or otherwise, perform a read of the register file 50, even if the instruction ultimately ends up using a forwarded value, because the pipeline does not know ahead of time whether the instruction will use the register value or a forwarded value instead. However, in the disclosed embodiments software renaming eliminates the redundant register-file read in forwarding operations by instructing the hardware that a forwarded value will be used.

The final set of registers result0*, resultl*, result2*, result3* 98, 100, 102, 104 are not present in the prior art. These registers retain the values of instructions that are two cycles ahead in the pipeline. Thus, this embodiment is able to forward to the execute stage 58, 72, 74, 76 when instructions two ahead of it are in the writeback stage 61, 78, 80, 82. For example, if an instruction in the writeback stage 61, 78, 80, 82 produces a value that an instruction in the decode stage 48, 60, 62, 64 requires, the data is forwarded under the control of the compiler, and the register-file read operation in the decode stage is disabled for that operand. This embodiment avoids writing and reading the register file 50, which saves power and also saves bits in the instruction word (the instruction producing the value does not need a register specifier to write the register file, thereby saving bits). Instead, the value is forwarded directly from the last registers 98, 100, 102, 104 to an instruction requiring that data, as in prior art data forwarding, only this is under the control of software, not hardware.

Thus, these features of the disclosed embodiment require extra registers 98, 100, 102, 104 and, as noted, one could extend these additional FIFO registers further for other, similar, direct data forwarding.

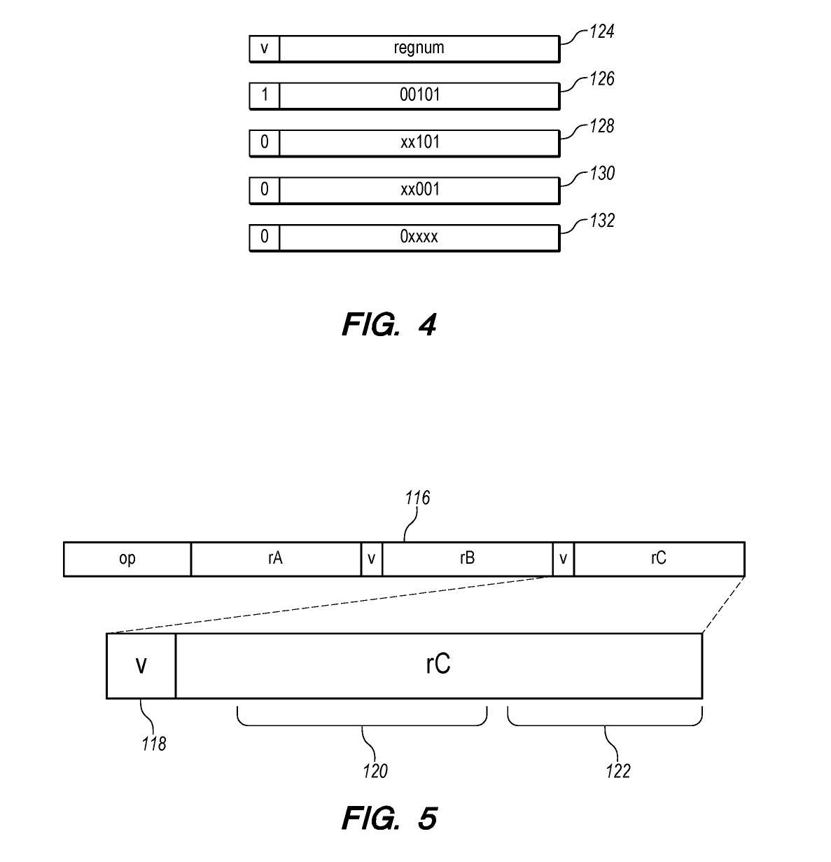

FIG. 4 shows an example register-specifier format and behavior in the pipeline shown in FIG. 3. In this embodiment, the instruction word's register specifier 124 bit-vector includes a valid bit v 124 and a register number regnum 124. The first example shows a bit-vector with a valid bit equal to 1, indicating a valid register specifier 126; in this instance, r5 is read from the register file in the decode stage. The next example 128 shows a bit-vector with a valid bit equal to 0, indicating a forwarding path; in this instance, the register file is not read, and pipeline 01′s current output (resultl in FIG. 3) is chosen. The next example 130 shows a bit-vector with a valid bit equal to 0, indicating a forwarding path; in this instance, the register file is not read, and pipeline 01′s previous output (resultl*, 74 in FIG. 3) is chosen. And finally, the last example 132 shows a bit-vector with a valid bit equal to 0 and topmost regnum bit equal to 0, indicating a short immediate value (or “0000” value indicates long immediate).

FIG. 5 shows the instruction format in more detail. A valid bit 118 associated with an operand 116 identifies whether the operand should be read from the register file or not; in the case of a ‘1’ valid bit, the register file is read. A ‘0’ valid bit indicates that the register-file read can be gated off, thereby saving power, and either the instruction contains an immediate value, or the register-specifier field indicates which pipeline is producing the result and how many cycles ahead from the current instruction it is.

The 4-pipeline scheme uses three bits to identify a forwarding path: one bit to indicate which stage produces the forwarded result (either the writeback stage, which is the previously produced value, or the value before that, which is saved in an additional pipeline register beyond the writeback stage), and two bits to indicate the pipe source (either result0, resultl, result2, or result3). This obviously scales to both wider and longer pipelines. In particular, if the register file is large enough, then the register specifier may be wide enough that a dedicated valid bit is not necessary, and a subset of the registers can be sacrificed to indicate forwarding. For example, in FIG. 5 there is space between the valid bit and the forwarding information 120 122. This bit or set of bits can be used in place of a valid bit: for instance, if this bit or vector of bits is all 1's, then the remainder of the register specifier is treated as forwarding information or an immediate, otherwise the register field indicates a register value in the register file.

A significant benefit of the mechanism is shown in FIG. 7: by using software register renaming, the architecture can dedicate some instructions in the VLIW instruction-word to handle only instructions that write temporary register values, which are not long-lived and whose output values will be produced and consumed entirely within the pipeline, never needing to be written to the register file. For these instructions, the architecture can eliminate the write-register specifier in the instruction word, which saves bits in the instruction word, thereby dissipating less power on instruction fetch or making room for more instructions in the instruction word (and therefore more parallelism) or a larger register file (and thus longer register specifiers in the instruction word). It also allows the corresponding pipelines in the processor core to eliminate a register-file write-port connection, thereby saving both die area and power dissipation.

As noted, supporting precise exceptions requires attention: if a producer-consumer pair is separated by an interrupt, the data can be lost. In the prior, in some solutions, an interrupt forces temporary data into the register file when an exception is raised. However, that technique is only possible if each producer has a register-file target specified in the instruction word. This requires a full register specifier to indicate the target register for every operation in the VLIW instruction word, and every pipeline. In the disclosed embodiments, only a subset of the pipelines is allowed to write the register file; the remaining pipelines only write into the forwarding registers and have no corresponding bits in the instruction word dedicated to holding a target-register specifier. This saves numerous bits in the VLIW instruction word, and it also eliminates wires connecting the corresponding pipeline or pipelines to the register file. Thus, the disclosed embodiments and the prior art solutions are quite different.

To address precise interrupts, the disclosed embodiments can mirror typical software practices in the design of drivers, firmware, and other low-level software: each instruction can contain a marker to designate critical sections and hold off the handling of an interrupt until after the critical section exits the pipeline. If an exception occurs that would lead to killing the process (a software error as opposed to an external interrupt), then the critical section is ignored, and the exception is handled. Alternatively, the forwarding registers can be saved and restored during interrupt handling and context switches, just like the registers in the register file.

In the disclosed embodiments software register-renaming has the advantageous effect of reducing the amount of register-file read and write energy the more it is used. The effect on reads was mentioned above. The effect on writes is similar to Tomasulo's Algorithm: when temporary values are produced and consumed within a short number of cycles, they never need to be written to the register file, and software register-renaming enables the pipeline to consume these temporary values immediately without ever writing them to the register file. They are simply produced and consumed within the pipeline and are never written out. Moreover, experiments show that one can use significantly fewer write ports on a VLIW register file than the number of pipelines. Those pipelines that do not write to the register file are hardwired not to do so, and their instruction words contain no bits for the rA target register 116 (the rA component in FIG. 3, 116 is not present for pipelines that do not write the register file). This saves a substantial number of bits in the instruction word, allowing for more instructions, or a larger opcode, or a larger register file.

### Disjunct Register File

A complementary embodiment, which can be used in conjunction with software register renaming and does not have the issues with interrupt handling, is a disjunct register file. This mechanism reduces the size of the register specifiers of both the read type and the write type, thereby making extra room in the instruction word for more instructions and thus higher performance. It also reduces the wiring requirements to attach the pipelines to the register file, and, like software register renaming, it significantly reduces the read/write power dissipated in the register file.

In VLIW implementations, or indeed in any wide-issue architecture whether VLIW or not, the complicated wiring of connecting multiple pipelines to the register file can cause the register-file design to require significant die area and significant power dissipation. In an 8-issue architecture, there are eight independent pipelines, and each has its own read and write ports on the register file. This means that, without software register renaming, or asymmetric pipeline design, the register file must have at least 16 read ports and 8 write ports. This large number of ports can cause register file designs to become unacceptably large and dissipate significant power. However, the wiring does not scale proportionally: in other words, the size of a 32-entry register file with 16 read ports and 8 write ports is more than twice the die area of a 16-entry register file with 16 read ports and 8 write ports. We exploit this fact by having two register files, one large, and one small, and only the small register file supports all 16 readers and 8 writers.

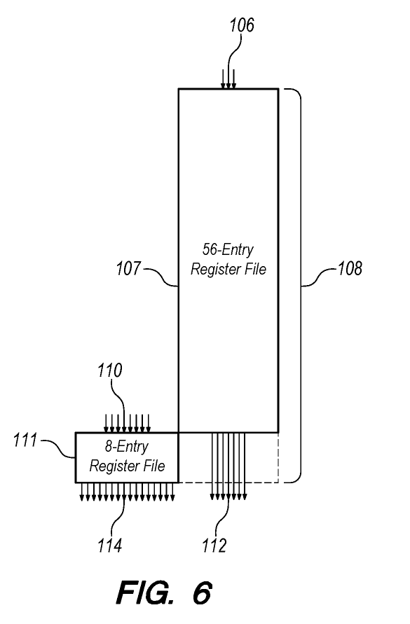

FIG. 6 illustrates an embodiment of a disjunct register file that creates a large register file out of two smaller ones. In this embodiment, an 8-entry register file 111 has eight write ports 110 and sixteen read ports 114 and would therefore be capable of fully supporting eight separate pipelines and thus an 8-wide VLIW architecture. The 56-entry register file 107, created by truncating a 64-entry register file 108 has fewer read/write ports (the remaining registers can be discarded or used as control registers). In this embodiment the larger physical register file has seven read ports 112 and three write ports 106. This would support only a subset of the pipelines in the 8-way VLIW architecture, but it would dissipate far less power than a fully connected 64-entry or 56-entry register file with 16 read ports and 8 write ports. As noted, most values produced in the pipeline are produced and then consumed in a very short span of time. Therefore, the smaller 8-entry register file 111 can serve as a focal point for these short-lived values, and the larger register file 108 can hold the longer-lived values. The smaller register file dissipates less read/write power, and so the more common operations that produce short-lived values dissipate less power than they would if they used a full 64-entry register file.

Pipelines connected to both the smaller and larger register files have a MUX to choose which register file to access, or they simply bypass the first stages of the register file address decoder. The choice is based upon the register number (in this example, register numbers 0-7 111 indicate the smaller physical register file; register numbers 8-63 107 indicate the larger physical register file). Pipelines connected only to the smaller register file 111 would only be able to read and/or write registers 0-7 111 and therefore would only need 3-bit register specifiers in the instruction word, whereas any port that had access to the entire register file 108 would require a 6-bit register specifier. Pipelines which could only write to the smaller file (whether capable of reading from the larger file or not) would be assigned instructions that generate short-lived values. In the worst case, when too many instructions need to write to the topmost 56 registers 107, the values can be first written to the bottom 8 registers 111 and then moved up to the larger register file 107 at a later point.

A disjunct register file is thus a single, logically monolithic register file, composed of two parts: a small physical register file, small when compared to the size of the rest of the file, and the larger rest of the file, however large it may be. But all subsets of the disjunct register file are not fully connected to all pipelines (“fully connected” meaning, for instance, having two read ports and one write port per pipeline). All or most of the pipelines are fully connected to the smaller physical register file, and only a subset of the processor pipelines is connected fully or partially to the larger rest of the file, whereby the wiring penalty on the integrated circuit die is kept at a minimum, and the power dissipation is reduced significantly compared to a full-size, fully connected register file.

This embodiment is not the same thing as a hierarchical register file; the present embodiment allows the architecture to use smaller register-specifier numbers, thereby decreasing the number of bits needed in the VLIW instruction word. A register value in the small register file does not have or need a shadow copy in the large register file. The mechanism also allows one to reduce register-file wiring needs by limiting the number of read/write ports on the larger file: the number of ports can be held to whatever the maximum value that will produce an acceptable die area requirement for the register file.

### Conclusion

Any one of these methods or devices—forwarding and register-file ports, multicore chips of VLIW cores, renaming registers in software, and disjunct register files—could be used separately or together to significantly increase the chip-wide OPS without a significant increase in the power requirements. These mechanisms combine to produce a high-performance but power-efficient design that can scale to extremely large performance levels without paying the same power and energy costs of competing technologies.

Although the present invention has been described with reference to preferred embodiments, numerous other features and advantages of the present invention are readily apparent from the above detailed description, plus the accompanying drawings, and the appended claims. Those skilled in the art will recognize that changes may be made in form and detail without departing from the spirit and scope of the invention disclosed herein.

I claim:

1. A very long instruction word (VLIW) processor comprising multiple instruction pipelines, one or more of the pipelines having multiple stages;
a VLIW instruction-word compiled with multiple parallel instructions to be executed by the instruction pipelines;
the VLIW processor having multiple data-forwarding paths that allow data from one pipeline to be used by another pipeline without having to be written through to the register file first;
the VLIW instruction-word containing information that explicitly directs the flow of the data on the data-forwarding paths;
at least one of the instructions in the VLIW instruction word having no write-register specifier;
the corresponding pipeline having no write-port connection to the register file;
the pipeline executing regular instructions that would normally write the register file.

2. The VLIW processor according to claim 1, further comprising:
a compiler capable of exploiting the VLIW processor parallelism to the extent an application has said parallelism; and
the data-forwarding paths.

3. The VLIW processor according to claim 1, further comprising:
m pipeline stages between register-file-read and register-file-write stages in the VLIW processor pipeline;
the width n of the machine, the width comprised of the number of instruction pipelines;
thereby creating at least mn data-forwarding paths.

4. The VLIW processor according to claim 2, further comprising:
registers renamed by the compiler to reference explicitly the data-forwarding paths;
whereby power is conserved because there is no comparison between instructions during pipeline operation.

5. The VLIW processor according to claim 1, further comprising:
registers renamed by a compiler to reference explicitly the data-forwarding paths;
whereby power is conserved because there is no comparison between instructions during pipeline operation.

6. The VLIW processor according to claim 1 wherein:
the VLIW processor is a 4-pipeline VLIW processor and uses three bits to identify a forwarding path;
one bit of the three bits indicates which pipeline stage produces the forwarded result; and
two bits indicates which pipeline is the source.

7. The VLIW processor according to claim 6 wherein:
the processor includes additional FIFO registers beyond the end of the pipeline to hold forwarding values; and
the processor uses more than one bit to indicate which pipeline stage produces the forwarded result, thereby scaling to more forwarding paths selectable by the compiler.

8. A processor core comprising multiple instruction pipelines and having an architecturally specified monolithic register file of R registers;
the processor core containing a plurality of physical register files, at least one of which has fewer than R registers;
one or more of the instruction pipelines connected to each of the physical register files.

9. The processor core of claim 8 further comprising:
forwarding which enables data to be sent directly from a later stage in a pipeline without requiring the earlier stage to wait to get the data out of one of the physical register files.

10. The processor core of claim 9 wherein:
the instruction pipelines dynamically detect when one instruction reads a register that an instruction ahead of it in the pipeline writes; and
an enabled MUX, corresponding to the register, directly passes data to the instruction pipeline needing the data without having to go through an intervening register.

11. The processor core of claim 8 further comprising:
a compiler inserts embedded forwarding signals in a multi-pipeline instruction;
the embedded forwarding signals in the compiled multi-pipeline instruction pipeline forward data to another pipeline in a pipeline core group.

12. A disjunct register file comprising:
a single, logically monolithic register file, composed of two parts;
(1) a small physical register file, small when compared to the size of the logically monolithic register file, and
(2) a larger physical register file making up the rest of the logically monolithic register file;
most of pipelines in a processor core connect to the small physical register file; and
a subset of the pipelines connect to the larger physical register file;
whereby wiring on an integrated circuit die is less than that required of a full-sized physical register file connected to all pipelines.

13. A disjunct register file comprising:
a single, logically monolithic register file, composed of two parts;
(1) a small physical register file, small when compared to the size of the logically monolithic register file, and
(2) a larger physical register file making up the rest of the logically monolithic register file;
most of pipelines in a processor core connect to the small physical register file; and
a subset of the pipelines connect to the larger physical register file;
whereby register-file read/write power on an integrated circuit die is less than that required of a full-sized physical register file connected to all pipelines.

14. A manycore chip containing multiple processing cores;
each core being a very long instruction word (VLIW) processor core;
whereby off-chip bandwidth is reduced compared to a manycore chip containing a comparable number of pipelines but arranged as single-issue pipelines.

15. A manycore chip containing multiple processing cores;
each core being a very long instruction word (VLIW) processor core;
whereby power dissipation is reduced compared to a manycore chip containing a comparable number of pipelines but arranged as dynamically scheduled out-of-order pipelines.
